(19) United States
(12) Patent Application Publication
(10) Pub. No.: US 2009/0244729 A1
(43) Pub. Date: Oct. 1, 2009

(54) METHOD FOR MANUFACTURING OPTICAL ELEMENT, OPTICAL ELEMENT UNIT, AND IMAGING UNIT

(76) Inventors: Setsuo Tokuhiro, Tokyo (JP); Takuji Hatano, Tokyo (JP); Masaaki Nose, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/412,061

(22) Filed: Mar. 26, 2009

(30) Foreign Application Priority Data
Mar. 31, 2008 (JP) JP2008-090825

(51) Int. Cl. G02B 7/02; B29D 11/00

(52) U.S. Cl. 359/821; 264/1.7

(57) ABSTRACT

A method for manufacturing an optical element Being resistant to reflow treatment, to realize board mounting of electronic parts by melting of a conductive paste by heat, comprising the step of: (i) forming an antireflective film on an optical element body composed of a thermosetting resin, wherein a film making temperature in a process of forming the antireflective film is maintained in a range of −40 to +40 ° C. with respect to a melting temperature of the conductive paste.

This application is based on Japanese Patent Application No. 2008-090825 filed on Mar. 31, 2008, in Japanese Patent Office, the entire content of which is hereby incorporated by reference.

### TECHNICAL FIELD

The present invention relates to an optical element manufacturing method, an optical element unit, and an imaging unit.

### BACKGROUND

Generally, when light is incident on a boundary surface of different refractive index, part of the incident light is reflected based on the refractive index ratio of both sides of the boundary surface. When the ratio of refractive indices at the boundary becomes larger, the amount of light reflected on the boundary surface increases. For example, with regard to thermoplastic plastics (thermoplastic resins) used as optical parts, refractive index is in the range of about 1.5-1.6. Therefore, when light is incident from a medium such as air, 4-5% of the incident light is reflected.

This surface reflection phenomenon produces the problem that not only the amount of transmitted light is decreased, but also major causes of ghost and flare are produced when such optical parts as such are used for camera lenses. Thus, to reduce this surface reflection, a method is frequently carried out wherein a thin dielectric film of light wavelength order is provided on the surface of an optical part and thereby reflected light is reduced via an interference effect of light within the film. A number of methods have been proposed wherein as a high-performance antireflective film structure, several layers are laminated using dielectric films of at least 2 types to realize low refractive index in a wide wavelength range.

In contrast, a technology has been developed to manufacture electronic modules at low cost via a technique wherein in cases in which IC (Integrated Circuits) chips and other electronic parts are mounted on a circuit board, conductive paste (for example, solder) is previously subjected to coating (potting) on predetermined locations of a circuit board, and then the circuit board is subjected to reflow treatment (heating treatment) in a state where electronic parts are placed at the locations to mount the electronic parts on the circuit board by melting the conductive paste (for example, Patent Document 1). Over recent years, optical modules (imaging units) have been being manufactured wherein an optical element, in addition to electronic parts, are placed on a circuit board, followed by reflow treatment as described above, whereby the electronic parts and the optical element are simultaneously mounted on the circuit board, resulting in an electronic module united with the optical element.

An optical element composed of glass can respond to reflow treatment temperatures (for example, 260° C.) with no damage thereto noted. However, in cases in which an optical element is composed of glass, when its lens section is formed into a spherical shape via polishing, there is produced the problem that the number of optical elements is increased. On the other hand, also when the lens section is formed into an aspherical shape via a glass molding method, the problem of poor productivity and increased cost is produced, compared to a resin molding method.

Therefore, it has been desirable to realize a technique wherein an optical element is composed of a resin to be able to respond to reflow treatment. However, when used as the above resin, a thermoplastic resin is unable to withstand reflow treatment temperatures (for example, 260° C.), since the glass transition point of a thermoplastic resin is normally about 150° C.

In contrast, when an optical element is composed of a thermosetting resin, the thermosetting resin exhibits high glass transition point and then can respond to reflow treatment, and therefore is suitable for an optical element material. Further, an antireflective film is formed on the surface of an optical element body in order to increase transmittance and reduce flare and ghost due to reflected light. However, when an antireflective film is formed on an optical element body, it is assumed that the adverse effect of heat applied to reflow treatment results in occurrence of cracks (so-called film cracks) in the antireflective film or a loss resulting from light absorption within the antireflective film.

[Patent Document 1] Unexamined Japanese Patent Application Publication (hereinafter, referred to as JP-A No.) 2001-24320

### DISCLOSURE OF THE INVENTION

### Problems to be Solved by the Invention

Incidentally, the melting temperature of solder commonly used as conductive paste tends to increase due to lead-free soldering and is usually about 220-240° C. On the other hand, temperature setting during reflow treatment, as well as solder selection, is an item set by a mounting company, being not decided based on circumstances of an optical element supplier. Generally, temperature during reflow treatment is set at a temperature up to the melting temperature of solder plus 20° C. Accordingly, durability as an optical element needs to be guaranteed up to this temperature.

### SUMMARY

An object of the present invention is to provide a method for manufacturing an optical element, wherein with the guarantee of durability as an optical element, at least crack occurrence of an antireflective film and a decrease in light transmission properties can also be inhibited. Another object of the present invention is to provide an optical element unit and an imaging unit utilizing an optical element manufactured via the optical element manufacturing method.

### Means to Solve the Problems

According to an embodiment of the present invention, in an optical element manufacturing method which can respond to reflow treatment to realize board mounting of electronic parts by melting conductive paste by heat, an optical element manufacturing method incorporating a process to form an antireflective film on an optical element body composed of a thermosetting resin is provided wherein in the process to form an antireflective film, film forming temperature is kept in the range of −40 to +40° C. with respect to the melting temperature of the conductive paste.

In the process to form an antireflective film, film forming temperature is preferably kept in the range of −20 to +20° C. with respect to the melting temperature of the conductive paste.

Further, in the process to form an antireflective film, 2-7 layers are alternately laminated using a layer composed of a lower refractive index material of a refractive index of less than 1.7 and a layer composed of a higher refractive index material of a refractive index of at least 1.7, and the higher refractive index material is any of Ta₂O₅, a mixture of Ta₂O₅ and TiO₂, ZrO₂, and a mixture of ZrO₂ and TiO₂.

Further, the above thermosetting resin is preferably an acrylic resin.

According to another embodiment of the present invention, there are provided an optical element manufactured via the above optical element manufacturing method; and an optical element unit provided with an aperture to adjust the amount of light entering the above optical element and a spacer to adjust the arrangement position of the optical element.

According to another embodiment of the present invention, there are provided an optical unit having an optical element manufactured via the optical element manufacturing method, an aperture to adjust the amount of light entering the optical element, and a spacer to adjust the arrangement position of the optical element; and an imaging unit provided with a sensor device to receive light transmitted from the optical element unit and a casing to cover the optical element unit and the sensor device.

### Effects of the Invention

In the present invention, with regard to an antireflective film formed on an optical element body, temperature during film formation of the antireflective film was investigated. Thereby, it was found that when the antireflective film is formed in the range of −40-+40° C. with respect to the melting temperature of conductive paste such as solder, durability to an ambient temperature up to the melting temperature of the conductive paste plus 20° C. was realized. Thus, at least crack occurrence of an antireflective film and a decrease in light transmission properties can be inhibited.

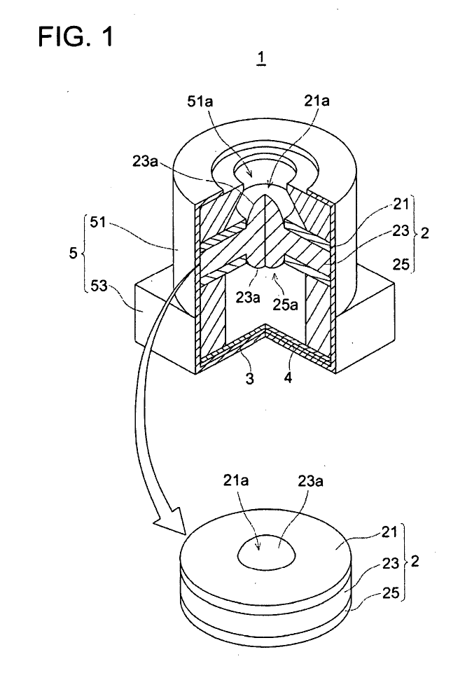

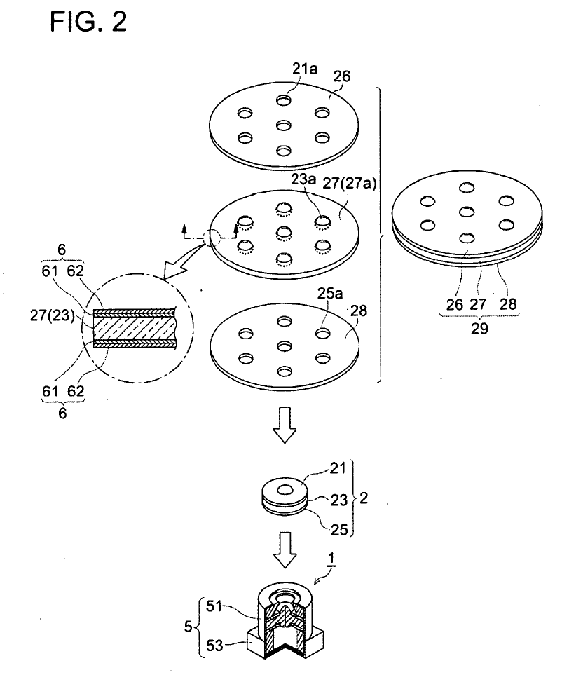

### BRIEF DESCRIPTION OF THE DRAWINGS

[FIG. 1] An exploded perspective view showing a schematic constitution of an imaging unit according to the preferred embodiment of the present invention

[FIG. 2] A diagram to describe a schematic manufacturing method of an imaging unit according to the preferred embodiment of the present invention

### DESCRIPTION OF THE PREFERRED EMBODIMENT

Next, the preferred embodiment of the present invention will now be described with reference to drawings.

As shown in FIG. 1, imaging unit 1 according to the preferred embodiment of the present invention is mainly constituted of lens unit 2, IR cutting filter 3, sensor device 4, and casing 5, having a constitution wherein lens unit 2, IR cutting filter 3, and sensor device 4 are covered with casing 5.

Casing 5 is constituted of cylindrical section 51 of a cylindrical shape and base section 53 of a rectangular parallelepiped shape. Cylindrical section 51 and base section 53 are integrally molded, and cylindrical section 51 is arranged on base section 53 in a standing manner. In the interior of cylindrical section 51, lens unit 2 is arranged. In the top plate portion of cylindrical section 51, light transmission hole 51a of a circular shape is formed. In the interior (bottom portion) of base section 53, IR cutting filter 3 and sensor device 4 are arranged.

As shown in the enlarged view of FIG. 1, lens unit 2 is mainly constituted of aperture 21, lens body 23, and spacer 25. These members each are stacked in such a manner that lens body 23 is arranged between aperture 21 and spacer 25. The central portion of lens section 23 is convex on each of the front and the rear surface, serving as lend section 23a to exhibit an optical function. Aperture 21 is a member to adjust the amount of light entering lens body 23. In the portion of the aperture corresponding to lens section 23a, opening section 21a of a circular shape is formed. Spacer 25 is a member to adjust the arrangement position (height position) of lens unit 51 in cylindrical section 51 of casing 5. In the portion of the spacer corresponding to lens section 23a, opening section 25a of a circular shape is also formed (refer to the upper part of FIG. 1).

Above imaging unit 1 has such a constitution that external light enters lens unit 1 through light transmission hole 51a; the incident light is subjected to light amount adjustment by opening section 21a of aperture 21 and transmitted through lens section 23a of lens body 23, and then is output from opening section 25a of spacer 25 toward IR cutting filter 4; and thereafter, the output light is subjected to IR cutting using IR cutting filter 4 and finally enters sensor device 4.

Lens body 23 of lens unit 2 is composed of a thermosetting resin. Specifically, there are usable (1) acrylic resins, (2) resins having an adamantane skeleton, (3) resins containing an acrylate compound or an allyl ester compound, (4) silicone resins, (5) epoxy resins, and (6) vinylester resins, as described below.

(1) Acrylic Resins

Typical examples of acrylic resins include (meth)acrylate resins. (Meth)acrylate resins used in the embodiment of the present invention are not specifically limited. Mono(meth)acrylates and multifunctional (meth)acrylates produced via a common production method can be used. (Meth)acrylates having an alicyclic structure such as tricyclodecane dimethanol azrylate or isoboronyl acrylate are preferably used. However, common alkyl acrylates and polyethylene glycol diacrylate are also usable.

Further, when mono(meth)acrylates are used as a reactive monomer, other examples include methyl acrylate, methyl methacrylate, n-butyl acrylate, n-butyl methacrylate, 2-ethylhexyl acrylate, 2-ethylhexyl methacrylate, isobutyl acrylate, isobutyl methacrylate, tert-butyl acrylate, tert-butyl methacrylate, phenyl acrylate, phenyl methacrylate, benzyl acrylate, benzyl methacrylate, cyclohexyl acrylate, and cyclohexyl methacrylate.

As multifunctional (meth)acrylates, there are listed, for example, trimethylolpropane tri(meth)acrylate, pentaerythritol tetra(meth)acrylate, pentaerythritol tri(meth)acrylate, dipentaerythritol hexa(meth)acrylate, dipentaerythritol penta(meth)acrylate, dipentaerythritol tetra(meth)acrylate, dipentaerythritol tri(meth)acrylate, tripentaerythritol octa(meth)acrylate, tripentaerythritol hepta(meth)acrylate, tripentaerythritol hexa(meth)acrylate, tripentaerythritol penta(meth)acrylate, tripentaerythritol tetra(meth)acrylate, and tripentaerythritol tri(meth)acrylate.

When any of the above (meth)acrylates is used, as a polymerization initiator, there are listed, for example, hydroperoxides, dialkyl peroxides, peroxyesters, diacyl peroxides, peroxycarbonates, peroxyketals, and ketone peroxides. Specifically, there are cited 1,1-di(t-hexyl peroxy)-3,3,5-trimethylcyclohexane, 1,1-di(t-hexyl peroxy)cyclohexane, 1,1-di(t-butyl peroxy)-2-methylcyclohexane, 1,1-di(t-butyl peroxy)cyclohexane, 1,1,3,3-tetramethylbutyl hydroperoxide, cumene hydroperoxide, di(2-t-butyl peroxy)benzene, dicumyl peroxide, 2,5-dimethyl-2,5-di(t-butyl peroxy)hexane, t-butylcumyl peroxide, di-t-butyl peroxide, dilauryl peroxide, dibenzoyl peroxide, di(4-t-butylcyclohexyl) peroxycarbonate, di(2-ethylhexyl) peroxycarbonate, 1,1,3,3-tetramethylbutyl peroxy-2-ethylhexanoate, t-hexyl peroxy-2-ethylhexanoate, t-butyl peroxy-2-ethylhexanoate, t-hexyl peroxyisopropyl monocarbonate, t-butyl peroxylaurate, t-butyl peroxyisopropyl monocarbonate, t-butylperoxy-2-ethylhexyl monocarbonate, t-hexyl peroxybenzoate, 2,5-dimethyl-2,5-di(benzoyl peroxy)hexane, and t-butyl peroxybenzoate.

(2) Resins Having an Adamantane Skeleton

Usable are 2-alkyl-2-adamantyl(meth)acrylates (refer to JP-A 2002-193883), 3,3′-dialkoxycarbonyl-1,1′-biadamantanes (refer to JP-A No. 2001-253835), 1,1′-biadamantane compounds (refer to U.S. Pat. No. 3,342,880 specification), tetraadamantanes (refer to JP-A 2006-169177), 2-alkyl-2-hydroxyadamantanes, 2-alkyleneadamantanes, curable resins having an adamantane skeleton with no aromatic ring such as di-tert-butyl 1,3-adamantanedicarboxylate (refer to JP-A 2001-322950), and bis(hydroxyphenyl)adamantanes and bis(glycidyloxyphenyl)adamantanes (refer to JP-A Nos. 11-35522 and 10-130371).

(3) Resins Containing an Acrylate Compound or an Allyl Ester Compound

There are preferably used bromine-containing (meth)allyl esters having no aromatic ring (refer to JP-A 2003-66201), allyl(meth)acrylates (refer to JP-A 5-286896), allyl ester resins (refer to JP-A Nos. 5-286896 and 2003-66201), copolymers of acrylic acid esters and epoxy group-containing unsaturated compounds (refer to JP-A 2003-128725), acrylate compounds (refer to JP-A 2003-147072), and acrylic ester compounds (refer to JP-A 2005-2064).

(4) Silicone Resins

Usable are silicone resins containing siloxane bonds as Si—O—Si backbones. As these silicone resins, silicone resins composed of a given amount of polyorganosiloxane resins can be used (for example, refer to JP-A 6-9937).

Thermosetting polyorganosiloxane resins are not specifically limited provided that the resins are formed into a three dimensional network structure via a siloxane bonding skeleton by continuous hydrolysis-dehydration condensation reaction by heating, generally exhibiting curing properties when heated for a long period of time at high temperature and having properties wherein softening by heating hardly occurs again once cured.

Such polyorganosiloxane resins contain a constituent unit represented by following Formula (A), and the shape thereof is any of a chain, a ring, and a network shape.

((R₁) (R₂) SiO)ₙ (A)

In Formula (A), “R₁” and “R₂” represent a substituted or unsubstituted monovalent hydrocarbon group of the same type or such groups of different type. Specifically, as “R₁” and “R₂”, there are exemplified an alkyl group such as a methyl group, an ethyl group, a propyl group, or a butyl group, an alkenyl group such as a vinyl group or an allyl group, an aryl group such as a phenyl group or a tolyl group, and a cycloalkyl group such as a cyclohexyl group or a cyclooctyl group; or groups wherein hydrogen atoms joining carbon atoms of these groups are substituted with a halogen atom, a cyano group, or an amino group, including, for example, a chloromethyl group, a 3,3,3-trifluoropropyl group, a cyanomethyl group, a γ-aminopropyl group, and an N-β-aminoethyl)-γ-aminopropyl group. “R₁” and “R₂” also represent a group selected from a hydroxyl group and an alkoxy group. Further, in above Formula (A), “n” represents an integer of at least 50.

Polyorganosiloxane resins are commonly used via dissolution in a hydrocarbon based solvent such as toluene, xylene, or petroleum based solvent; or in a mixture of any of these and a polar solvent. Further, solvents of different compositions may be used provided that these are mutually soluble.

Production methods of a polyorganosiloxane resin are not specifically limited, and any of the methods known in the art are employable. For example, one type of organohalogensilane or a mixture of 2 types thereof is subjected to hydrolysis or alcoholysis to obtain the resin. A polyorganosiloxane resin generally contains a silanol group or a hydrolyzable group such as an alkoxy group. These groups are contained at a ratio of 1-10% by weight as a silanol group equivalent.

These reactions are commonly conducted in the presence of a solvent capable of melting an organohalogensilane. Further, there is usable a method of synthesizing a block copolymer wherein a straight-chain polyorganosiloxane having a hydroxyl group, an alkoxy group, or a halogen atom at molecular chain terminals is hydrolyzed together with organotrichlorosilane. The thus-prepared polyorganosiloxane resin usually contains residual HCl. In a composition of the embodiment of the present invention, those, containing the residual HCl at a ratio of at most 10 ppm, preferably at most 1 ppm, are preferably used in view of good storage stability.

(5) Epoxy Resins

As epoxy compounds, there can be listed, for example, novolac phenol type epoxy resins, biphenyl type epoxy resins, dicyclopentadiene type epoxy resins, bisphenol F diglycidyl ether, bisphenol A diglycidyl ether, 2,2′-bis(4-glycidyloxycyclohexyl)propane, 3,4-epoxycyclohexylmethyl-3,4-epoxycyclohexane carboxylate, vinylcyclohexene dioxide, 2-(3,4-epoxycyclohexyl)-5,5-spiro-(3,4- epoxycyclohexane)-1,3-dioxane, bis(3,4-epoxycyclohexyl)adipate, 1,2-cyclopropane dicarboxylic acid bisglycidyl ester, triglycidyl isocyanurate, monoallyldiglycidyl isocyanurate, and diallyldiglycidyl isocyanurate.

As hardeners, acid anhydride hardeners and phenol hardeners are preferably usable. Specific examples of acid anhydride hardeners include phthalic anhydride, maleic anhydride, trimellitic anhydride, pyromellitic anhydride, hexahydrophthalic anhydride, 3-methyl-hexahydrophthalic anhydride, 4-methyl-hexahydrophthalic anhydride or a mixture of 3-methyl-hexahydrophthalic anhydride and 4-methyl-hexahydrophthalic anhydride, tetrahydrophthalic anhydride, nadic anhydride, and methylnadic anhydride. Hardening accelerators are optionally contained if appropriate. Hardening accelerators are not specifically limited provided that these accelerators exhibit excellent hardening performance and are colorless, as well as not losing transparency of a thermosetting resin. Usable are, for example, imidazoles such as 2-ethyl-4-methylimidazole (2E4MZ), tertiary amines, quaternary ammonium salts, bicyclic amidines such as diazabicycloundecene and derivatives thereof, phosphine, and phosphonium salts. These may be used individually or in combination of at least 2 types thereof.

Antireflective film 6 (refer to the enlarged portion in the upper part of FIG. 2) is formed on each of the front and the rear surface of lens body 23 composed of a resin as described above. Antireflective film 6 has a 2-layered structure. First layer 61 is formed directly on lens body 23 and second layer 62 is formed on the first layer.

First layer 61 is a layer composed of a higher refractive index material having a refractive index of at least 1.7, preferably composed of any of Ta₂O₅, a mixture of Ta₂O₅ and TiO₂, ZrO₂, and a mixture of ZrO₂ and TiO₂. First layer 61 may be composed of TiO₂, Nb₂O₃, or HfO₂. Second layer 62 is a layer composed of a lower refractive index material having a refractive index of less than 1.7, preferably composed of SiO₂.

In antireflective film 61, first layer 61 and second layer 62 each are formed via a method such as vapor deposition. Specifically, first layer 61 and second layer 62 are formed while the film forming temperature is kept in the range of −40-+40° C. (preferably −20-+20° C.) with respect to the melting temperature of conductive paste such as solder applied to reflow treatment (to be further described later).

In lens unit 2, first layer 61 and second layer 62 may further be laminated alternately on first layer 61 and second layer 62 to obtain antireflective film 6 having a structure of 2-7 layers. In this case, a layer being in direct contact with lens body 23 may be either a higher refractive index material layer (first layer 61) or a lower refractive index material layer (second layer 62), depending on the kind of lens body 23a. In the embodiment of the resent invention, the layer being direct contact with lens body 23 is a higher refractive index material layer.

In imaging unit 1 provided with the above constitution, an embodiment is shown as one example of optical elements wherein antireflective film 6 is formed on lens body 23. Lens body 23 is shown as one example of optical element bodies, and lens unit 2 is shown as one example of optical element units.

Next, a manufacturing method of imaging unit 1 is described below with reference to FIG. 2.

As shown at the top of FIG. 2, there are prepared lens array 27 wherein a plurality of lens sections 23a are formed, aperture array 26 wherein opening sections 21a of the same number as lens sections 23a are formed, and spacer array 28 wherein opening sections 25a of the same number as lens sections 23a.

Lens array 27 is formed in such a manner that a thermosetting resin is injection-molded, and then on each of the front and the rear surface thereof, antireflective film 6 is entirely formed. Aperture array 26 and spacer array 28 are formed in such a manner that a thermosetting resin is colored black by mixing with carbon, and then the resulting resin is molded via an injection molding method.

Herein, antireflective film 6 in lens array 27 is formed as described below. Initially, lens array body 27a (lens array 27 without antireflective film 6) is mounted in a vacuum deposition apparatus. The pressure inside the apparatus is reduced down to a predetermined pressure (for example, 2×10⁻³ Pa), and at the same time, lens array body 27a is heated up to a predetermined temperature (for example, 240° C.) using the heater in the upper part of the vacuum deposition apparatus.

Thereafter, using a vapor deposition source used to constitute first layer 61, first layer 61 is formed. Especially, in this case, the film forming temperature is kept in the range of −40-+40° C. with respect to the melting temperature of conductive paste to be melted in reflow treatment.

For example, when a (Ta₂O₅+5% TiO₂) film is formed as first layer 61, using 0A600 (produced by Optorun Co., Ltd.) as a vapor deposition source, the vapor deposition source is vaporized via electron gun heating. It is preferable that during vapor deposition, O₂ gas is introduced until the pressure inside the vacuum deposition apparatus reaches 1.0×10⁻² Pa; and while the deposition rate is controlled at 5 Angstroms/second, film formation is carried out. When the melting temperature of conductive paste to be melted in reflow treatment is, for example, 240° C., the film forming temperature (the temperature inside the vapor deposition apparatus) is kept in the range of 200-280° C.

Then, in order to form first layer 61 on each surface of lens array body 27a, lens array body 27a is reversed by the reversing mechanism inside the vapor deposition apparatus to form first layer 61 on the rear surface in the same manner as described above (similarly to film formation of second layer 62 on the rear surface).

Thereafter, second layer 62 is subsequently formed on first layer 61 using a vapor deposition source used to constitute second layer 62. In this case, similarly to the case of formation of second layer 61, the film forming temperature is kept in the range of −40-+40° C. with respect to the melting temperature of conductive paste to be melted in reflow treatment.

For example, when an SiO₂ film is used as second layer 62, it is preferable that O₂ gas is introduced until the pressure inside the vacuum deposition apparatus reaches 1.0×10⁻² Pa; and while the deposition rate is controlled at 5 Angstroms/second, film formation is carried out. When the melting temperature of conductive paste to be melted in reflow treatment is, for example, 240° C., the film forming temperature (the temperature inside the vapor deposition apparatus) is kept in the range of 200-280° C.

Lens array 27 can be manufactured via the above processes.

After lens array 27 has been manufactured, there are bonded to lens array 27 aperture array 26 to produce narrow light beams to be arranged on the top of lenses in the same arrangement manner as lens section 23a; and spacer array 28 to perform height adjustment to be arranged at the bottom of the lenses in the same arrangement manner as lens section 23a, and then lens unit array 29 is manufactured. Thereafter, as shown in the middle part of and the bottom part of FIG. 2, lens unit array 29 is individuated to individual lens section 23a using an endmill to manufacture a plurality of lens units 2. Each of the lens units 2 is built into (allowed to adhere to) cylindrical section 51 of casing 5 to manufacture imaging unit 1.

After the manufacture of imaging unit 1, when imaging unit 1 and other electronic parts are simultaneously mounted on a circuit board, imaging unit 1 is placed, together with these other electronic parts, at predetermined mounting locations of a circuit board having previously been subjected to coating (potting) with conductive paste such as solder. Thereafter, the circuit board, on which imaging unit 1 and these other electronic parts have been placed, is conveyed to a reflow furnace (not shown in the figure) using a belt conveyer. Then, the circuit board is heated (subjected to reflow treatment) at about 230-270° C. for about 5-10 minutes. Thereby, via melting of the conductive paste, imaging unit 1 is mounted on the circuit board, together with the above other electronic parts.

According to the above embodiment of the present invention, when antireflective film 6 is formed, film forming temperature is kept in a predetermined temperature range of −40-+40° C. with respect to the melting temperature of conductive paste to be melted in reflow treatment, and thereby at least a decrease in optical transmittance of light entering imaging unit 1 can be inhibited and crack occurrence of antireflective film 6 can be inhibited even when subjected to reflow treatment (refer to the following example).

### EXAMPLE

(1) Sample Production

(1.1) Production of Samples 1-7

In this EXAMPLE, a tabular sample is employed as an optical element in order to examine the effects of the manufacturing method of this invention, however, a configuration of the optical element is not limited thereto, and any shaped material which exhibits some sort of an optical function by transmission or reflection of light can be employed without specific limitation.

Using A-DCP (tricyclodecanedimethanol diacrylate monomer) and PERBUTYL O (polymerization initiator, a kind of peroxide ester), plural acrylic flat plates of a thickness of 2 mm were produced via injection molding. In production of these acrylic flat plates, the resin was injected into a metal mold having been heated at the molding temperature while a cylinder was kept cooled at 10° C. via water cooing in order for the resin not to be lured in the cylinder. Then, heating was continued for a given period of time, followed by opening the metal mold to collect molded articles (acrylic flat plates).

Thereafter, 2 layers of an antireflective film were formed on each of the front and the rear surface of each of these acrylic flat plates via a vacuum vapor deposition method. Specifically, each acrylic flat plate was mounted in a vacuum vapor deposition apparatus. Then, the pressure inside the apparatus was reduced down to 2×10⁻³ Pa, and at the same time, the each acrylic flat plate was heated up to a predetermined temperature using the heater in the top part of the vacuum vapor deposition apparatus.

Herein, the predetermined temperature is 180-300° C. depending on the samples, corresponding to “Film Forming Temperature” described in Table 1.

Subsequently, as a first layered film, a (Ta₂O₅+5% TiO₂) film of 20 nm was formed directly on the front surface of the acrylic flat plate. Specifically, using 0A600 (produced by Optorun Co., Ltd.) as a vapor deposition source, the vapor deposition source is vaporized via electron gun heating to form the (Ta₂O₅+5% TiO₂) film. During vapor deposition, O₂ gas was introduced until the pressure inside the vacuum deposition apparatus reached 1.0×10⁻² Pa, and film formation was carried out while the deposition rate was controlled at 5 Angstroms/second.

Thereafter, the acrylic flat plate was reversed by the reversing mechanism inside the vapor deposition apparatus to form a (Ta₂O₅+5% TiO₂) film on the rear surface thereof in the same manner as described above (film formation on the rear surface is carried out in the same manner as for a second layered film and following ones).

Then, as a second layered film, an SiO₂ film of 110 nm was formed, being preceded by the first layered film. Also, in this case, O₂ gas was introduced until the pressure inside the vacuum deposition apparatus reached 1.0×10⁻² Pa, and film formation was carried out while the deposition rate was controlled at 5 Angstroms/second. Via the above processes, “samples 1-7” described in Table 1 were produced (“Sample No.” each is distinguished based on film forming temperature). Characteristic features of each of samples 1-7 such as the antireflective film and film forming temperature are listed in Table 1.

(1.2) Production of Samples 11-17

Following the second layered film of the antireflective film, a (Ta₂O₅+5% TiO₂) film as a third layer film and an SiO₂ film as a fourth layered film were formed in the same. manner as in (1.1) described above. “Samples 11-17” were produced in the same manner as in production of samples 1-7 except the conditions described above. Characteristic features of each of samples 11-17 such as the antireflective film and film forming temperature are listed in Table 2.

(1.3) Production of Samples 21-27

An SiO₂ film as a first layered film of the antireflective film was formed in the same manner as in the above (1.1). Thereafter, (Ta₂O₅+5% TiO₂) films and SiO₂ films were alternately formed as second-seventh layered films in the same manner as in (1.1). “Samples 21-27” were produced in the same manner as in production of samples 1-7 except the conditions described above. Characteristic features of each of samples 21-27 such as the antireflective film and film forming temperature are listed in Table 3.

(2) Sample Evaluation

To examine characteristics of the antireflective film of each of samples 1-7, 11-17, and 21-27, each of samples 1-7, 11-17, and 21-27 was heated at 260° C. for about 5-10 minutes (namely reflow treatment was carried out). After heating, with regard to each of samples 1-7, 11-17, and 21-27, the magnitude of light amount loss and the presence or absence of crack occurrence were examined to evaluate temperature durability.

(2.1) Light Amount Loss

Light of a wavelength of 405 nm was transmitted into each of samples 1-7, 11-17, and 21-27 to determine light amount loss at the time. Specifically, the incident amount of light was designated as 100%, and transmittance (%) and reflectance (%) were measured. These measured values were assigned to the expression: light loss amount (%)=100−(transmittance+reflectance) to obtain a value of the amount of light amount loss. This value was designated as an evaluation object for light amount loss. The light loss amounts and the evaluation results are shown in Tables 1-3.

In Table 1-3, the criteria for “A”, “B”, and “C” with respect to “light amount loss” evaluated are described below.

“A”: The light loss amount is less than 5%.

“B”: The light loss amount is 5% —less than 10%.

“C”: The light loss amount is at least 10%.

Cracks after Reflow

Each of samples 1-7, 11-17, and 21-27 was visually observed using a stereomicroscope. Then, temperature durability of the antireflective film was evaluated by the presence or absence of crack occurrence based on the observation results.

In Table 1-3, the criteria for “A”, “B”, and “C” with respect to “cracks after reflow” evaluated are described below. “A”: No crack is noted in the antireflective film. “B”: One-4 cracks are noted in the antireflective film. “C”: At least 5 cracks are noted in the antireflective film.

TABLE 1

| | | | | | | |
|---|---|---|---|---|---|---|
| 1 | 2 | 3 | 4 | 5 | 6 | 7 |

| | | | |
|---|---|---|---|
| Sample No. | Comp. | Example | Comp. |

| | | | | |
|---|---|---|---|---|
| Antireflective | Second | SiO₂ | Film | 110 |
| Film | Layered | | Thickness | |
| | First | Ta₂O₅ + | (nm) | 20 |
| | Layered | TiO₂(5%) | | |

| | | | |
|---|---|---|---|
| Bulk | Thermosetting | Thickness | 2 |
| | Acrylic Resin | (mm) | |

| Film Forming Temperature (° C.) | | 180 | 200 | 220 | 240 | 260 | 280 | 300 |
|---|---|---|---|---|---|---|---|---|
| Difference from Solder Melting Temperature | | −60 | −40 | −20 | 0 | +20 | +40 | +60 |
| (° C.) | | | | | | | | |
| Light Loss Amount (%) | | 1.90 | 2.50 | 3.10 | 4.80 | 5.50 | 6.20 | 12.00 |
| Evaluation | Light Amount Loss | A | A | A | A | B | B | C |
| | Cracks after Reflow | C | B | A | A | A | A | C |

Comp.: Comparative Example

TABLE 2

| | | | | | | |
|---|---|---|---|---|---|---|
| 11 | 12 | 13 | 14 | 15 | 16 | 17 |

| | | | |
|---|---|---|---|
| Sample No. | Comp. | Example | Comp. |

| | | | | |
|---|---|---|---|---|
| Antireflective | Fourth | SiO₂ | Film | 107 |
| Film | Layered | | Thickness | |
| | Third | Ta₂O₅ + | (nm) | 25 |
| | Layered | TiO₂(5%) | | |
| | Second | SiO₂ | | 46 |
| | Layered | | | |
| | First | Ta₂O₅ + | | 16 |
| | Layered | TiO₂(5%) | | |

| | | | |
|---|---|---|---|
| Bulk | Thermosetting | Thickness | 2 |
| | Acrylic Resin | (mm) | |

| Film Forming Temperature (° C.) | | 180 | 200 | 220 | 240 | 260 | 280 | 300 |
|---|---|---|---|---|---|---|---|---|
| Difference from Solder Melting Temperature | | −60 | −40 | −20 | 0 | +20 | +40 | +60 |
| (° C.) | | | | | | | | |
| Light Loss Amount (%) | | 2.00 | 2.80 | 2.90 | 5.50 | 6.80 | 7.50 | 12.80 |
| Evaluation | Light Amount Loss | A | A | A | B | B | B | C |
| | Cracks after Reflow | C | B | A | A | A | A | C |

Comp.: Comparative Example

TABLE 3

| | | | | | | |
|---|---|---|---|---|---|---|
| 21 | 22 | 23 | 24 | 25 | 26 | 27 |

| | | | |
|---|---|---|---|
| Sample No. | Comp. | Example | Comp. |

| | | | | |
|---|---|---|---|---|
| Antireflective | Seventh | SiO₂ | Film | 99 |
| Film | Layered | | Thickness | |
| | Sixth | Ta₂O₅ + | (nm) | 25 |
| | Layered | TiO₂(5%) | | |
| | Fifth | SiO₂ | | 20 |
| | Layered | | | |
| | Fourth | Ta₂O₅ + | | 11 |
| | Layered | TiO₂(5%) | | |
| | Third | SiO₂ | | 29 |
| | Layered | | | |
| | Second | Ta₂O₅ + | | 14 |
| | Layered | TiO₂(5%) | | |
| | First | SiO₂ | | 18 |
| | Layered | | | |

| | | | |
|---|---|---|---|
| Bulk | Thermosetting | Thickness | 2 |
| | Acrylic Resin | (mm) | |

| Film Forming Temperature (° C.) | | 180 | 200 | 220 | 240 | 260 | 280 | 300 |
|---|---|---|---|---|---|---|---|---|
| Difference from Solder Melting Temperature | | −60 | −40 | −20 | 0 | +20 | +40 | +60 |
| (° C.) | | | | | | | | |
| Light Loss Amount (%) | | 1.80 | 2.50 | 2.80 | 4.80 | 6.00 | 7.00 | 10.50 |
| Evaluation | Light Amount Loss | A | A | A | A | B | B | C |
| | Cracks after Reflow | C | B | B | A | A | A | C |

Comp.: Comparative Example

(3) Summary

As shown in Table 1 , with regard to samples 1-7, samples 2-6 exhibited less light amount loss than samples 1 and 7 and also no crack occurrence. Therefore, it is understood that it is effective to keep film forming temperature in the range of −40 to +40° C. with respect to the melting temperature (240° C.) of solder from the viewpoint of inhibiting light amount loss and cracks. Further, as shown in Table 2 and Table 3, when the number of layers of the antireflective film is increased to 4 and 7, respectively, the same results as described above were obtained. Accordingly, it is presumed that when the number of layers of the antireflective film is 2-7, the effects of inhibiting light amount loss and cracks can be maintained.

What is claimed is:

1. A method for manufacturing an optical element Being resistant to reflow treatment, to realize board mounting of electronic parts by melting of a conductive paste by heat, comprising the step of:
(i) forming an antireflective film on an optical element body composed of a thermosetting resin,
wherein a film making temperature in a process of forming the antireflective film is maintained in a range of −40 to +40° C. with respect to a melting temperature of the conductive paste.

2. The method for manufacturing an optical element described in claim 1,
wherein a film making temperature in the process of forming the antireflective film is maintained in a range of −20 to +20° C. with respect to the melting temperature of the conductive paste.

3. The method for manufacturing an optical element described in claim 1,
wherein, in the process of forming the antireflective film, a layer comprising a lower refractive index material having a refractive index of less than 1.7 and a layer comprising a higher refractive index material having a refractive index of at least 1.7 are alternatively laminated into 2-7 layers, and the higher refractive index material is any of Ta₂O₅, a mixture of Ta₂O₅ and TiO₂; and ZrO₂, and a mixture of ZrO₂ and TiO₂.

4. The method for manufacturing an optical element described in claim 1,
wherein the thermosetting resin is an acrylic resin.

5. An optical element unit comprising the optical element manufactured via the method for manufacturing the optical element described in claim 1, an aperture to adjust an amount of light entering the optical element, and a spacer to adjust an arrangement position of the optical element.

6. An image unit comprising the optical element unit described in claim 5, a sensor device to receive light transmitted from the optical element unit, and a casing to cover the optical element unit and the sensor device.
